(19) United States
(12) Patent Application Publication
(10) Pub. No.: US 2015/0280222 A1
(43) Pub. Date: Oct. 1, 2015

(54) METHOD, POWDER, FILM & LITHIUM ION BATTERY

(71) Applicant: INSTITUTT FOR ENERGITEKNIKK, Kjeller (NO)

(72) Inventor: Martin Kirkengen, Oslo (NO)

(73) Assignee: INSTITUTT FOR ENERGITEKNIKK, Kjeller (NO)

(21) Appl. No.: 14/436,646

(22) PCT Filed: Oct. 17, 2013
(86) PCT No.: PCT/EP2013/071761

§ 371 Date: Apr. 17, 2015

(30) Foreign Application Priority Data
Oct. 17, 2012 (NO) 20121230

(51) Int. Cl. H01M 4/36; H01M 4/587; H01M 4/04; H01M 10/0525

(52) U.S. Cl. CPC H01M 4/366; H01M 10/0525; H01M 4/587; H01M 4/0428; H01M 4/0402; H01M 4/0416

(57) ABSTRACT

Method for producing a powder of particles comprising a core region (26) and a shell region (28), said core region (26) comprising amorphous or microcrystalline Silicon and said core region (26) comprising a passivating material. The method comprises the steps of supplying a reactant gas (12) containing Silicon to a reaction chamber (16) of a reactor, and heating said reactant gas (12) to a temperature sufficient for thermal decomposition or reduction of the reactant gas (12) to take place inside the reaction chamber (16) to thereby produce nano- to micro-scale particles of amorphous or microcrystalline Silicon, and thereafter coating said particles with passivating material.

### TECHNICAL FIELD

The present invention concerns a method for producing a powder of particles comprising a core region and a shell region, said core region comprising amorphous or microcrystalline Silicon, and said shell region comprising a passivating material. The present invention also concerns a powder produced using such a method, a film comprising such powder, and a Lithium ion battery comprising at least one such film.

### BACKGROUND OF THE INVENTION

Chemical vapour deposition (CVD) is a chemical process used to produce high-purity, high-performance solid materials. The process is often used in the electronics, photovoltaic solar, and chemical industry to produce thin films or nano- to micro-scale particles, i.e. particles having a maximum transverse dimension of up to 100 μm. In a typical CVD process, a substrate (or “wafer”) is exposed to one or more volatile precursors, which react and/or decompose on the substrate surface to produce the desired deposit.

Materials may be deposited in various forms, including: monocrystalline, polycrystalline, amorphous and epitaxial. These materials include: silicon, carbon fibre, carbon nanofibre, carbon nanotubes, SiO₂, silicon-germanium, tungsten, silicon carbide, silicon nitride, silicon oxynitride, titanium nitride and synthetic diamond.

Several applications in which silicon is utilized require pure silicon as feedstock material. The currently dominating technology is the Siemens Reactor, whereby a silicon-containing reactant gas such as monosilane or trichlorosilane is decomposed, which results in the growth of a silicon film on a silicon filament. The Siemens reactor produces silicon rods that need to be crushed to chunks before further processing. Such crushing is not only expensive and time consuming but can also present contamination problems. The particles formed by crushing will usually have a wide distribution of shapes and sizes.

An alternative process is the Fluidized Bed Reactor where a particle bed is kept fluidized by an ascending gas stream. The reactant gas is heated to decomposition and deposits Silicon on the fluidized particles. The product is crystalline spherical Silicon beads of 2-5 mm in diameter. A bi-product is the formation of large quantities of silicon fines of varying morphology. For example, U.S. Pat. No. 4,314,525 concerns a process and apparatus for thermally decomposing silicon-containing gas for deposition on fluidized nucleating silicon seed particles. Silicon seed particles are produced in a secondary fluidized reactor by thermal decomposition of a silicon containing gas. The thermally produced silicon seed particles are then introduced into a primary fluidized bed reactor to form a fluidized bed. Silicon containing gas is introduced into the primary reactor where it is thermally decomposed and deposited on the fluidized silicon seed particles. Silicon seed particles having the desired amount of thermally decomposed silicon product thereon are removed from the primary fluidized reactor as an ultra-pure silicon product.

Yet another method is the Free Space Reactor where the reactant gas is heated to decomposition homogeneously in the gas phase. This method needs to be conducted inside a reaction chamber, but the deposition itself occurs favorably at silicon nuclei formed in the gas phase and not on the reactor walls. The product formed is nano- to micro-scale particles of amorphous or crystalline structure, depending on operating conditions.

Electrochemical batteries for energy storage can be produced in many ways. Currently, the battery chemistry seeing the fastest growth is the Li-ion battery. The key elements of this technology are the anode electrode, the cathode electrode, the electrolyte connecting the two internally in the battery, and the current collectors providing the external connection. During charge and discharge, the Lithium ions will diffuse through the electrolyte from the anode material to the cathode material and back. To preserve electric charge, a current of electrons is set up through the current collectors to balance the transport of the positively charged Li-ion transport.

The electrode usually takes the shape of a film, comprising the active material interacting with the Lithium, a binder ensuring adhesion of the material, and sometimes a conductive powder like graphite providing extra electron conductivity within the electrode. The active material can typically be introduced to the battery in the form of a powder.

Silicon is in general considered to be a very promising anode material for Li-ion batteries due to its very high Li-absorption capacity of up to 4.2 Lithium atoms per Silicon atom. There are reasons to assume that a high purity Si has advantages over metallurgical grade Si. In particular, high purity material will be more effectively doped, giving higher electron conductance, it will have fewer traps hindering Li-ion diffusion, and it will cause fewer side reactions. The Silicon powder produced using such methods as described above, is therefore potentially an excellent anode material for Li-ion batteries.

However, Silicon expands by up to 400% during the absorption of Lithium, meaning that for each cycle of charging and discharging the battery, the Silicon will expand and contract, often at different rates in different parts of the same Silicon particle. This can cause cracking of the Silicon particles, both exposing new surface for interactions with the electrolyte, and reducing the internal electron conductivity of the particles to the extent that some parts of the particle can become disconnected from the conductive network of the battery electrode.

Additionally, when embedded in a battery electrolyte, a Silicon surface will react chemically to produce a solid-electrolyte-interface (SEI) layer. During the cycling of the battery, this layer has been known to peel off, exposing clean surface, forming a new SEI and in this way consuming the electrolyte and degrading the battery. Conventionally, this problem has been solved using relatively large particles in order to decrease the surface to volume ratio of the particles. The disadvantage of this is that the diffusion length for the Li-ions in the particles increases and the diffusion over the interface between active material and electrolyte is slowed down, both slowing the kinetics and increasing the overpotential of the battery. Furthermore, during the handling of Silicon particles, they are likely to react with oxygen in the air, forming an oxide layer, which is detrimental to battery performance. Small silicon particles with correspondingly large surface areas are therefore highly flammable, making the powder a potential safety hazard.

### SUMMARY OF THE INVENTION

An object of the invention is to provide an improved method for producing Silicon powder, such as Silicon powder suitable for use in applications such as making an electrode for a Lithium ion battery.

This object is achieved by a method for producing a powder of particles comprising a core region and a shell region, the core region comprising amorphous or microcrystalline Silicon and the core region comprising a passivating material. The method comprises the steps of supplying a reactant gas containing Silicon to a reaction chamber of a reactor, such as a one-stage CVD Free Space Reactor, and heating the reactant gas to a temperature sufficient for thermal decomposition or reduction of the reactant gas to take place inside the reaction chamber to thereby produce nano- to micro-scale particles of amorphous or microcrystalline Silicon, and thereafter coating the particles with passivating material.

Large quantities of high purity nano- to micro-sized particles having a narrow size distribution and an amorphous Silicon core or a microcrystalline Silicon core (i.e. a non-metallic Silicon core) may thereby be produced in a controlled manner. The method therefore provides a high yield of homogeneous particles whereby no extra step, such as filtering, is required to ensure that a desired standard deviation in size distribution is achieved. Additionally, by passivating the core region Silicon particles, oxidation of the Silicon will be eliminated and the safety of handling the powder will be substantially improved.

Furthermore, if the coated particles are used in a battery, such as in the anode of a Lithium ion battery, SEI layer formation and electrolyte consumption will be reduced due to the passivation material. The passivating material in the shell region of the coated particles namely protects the highly reactive Silicon in the core region from both air and battery electrolyte. The uniform size distribution contributes to better control in the charging and discharging of individual particles. With large size variations, some particles will be fully lithiated while other particles are still far from filled. Thus the expansion of the smallest particles will be unnecessarily big. Similarly, the Li concentration gradient in the biggest particles will create internal tension, which can lead to cracking of these particles. The proposed uniformly sized and coated particles will therefore both have minimal expansion/contraction and be able to withstand expansion/contraction better than pure (un-coated) Silicon particles, and they will be easier to handle and include in a production line than pure Silicon particles.

According to an embodiment of the invention the method comprises the step of supplying at least one gas containing a metal, such as Copper or Iron, such as a metal-organic precursor gas, to the reaction chamber of the reactor during the formation of the core region Silicon particles. Adding a metallic compound to the core region in this way can improve the electrical conductivity of the particles and reduce cracking of the particles. It is though that this will work best if the metal forms segregated networks in the particles, meaning the metal content should be above the solubility limit of the metal in silicon.

According to another embodiment of the invention the method comprises the step of supplying at least one gas containing Lithium to the reaction chamber of the reactor to lithiate the core region. Lithium may be added to the core region so that the core region has a Lithium content in the range of 50 to 350 atomic-% of the core region's Silicon content.

Prelithiating the core region of the particles will improve battery performance if the coated particles are used in a battery, such as a Lithium ion battery. Including Lithium in the core region before forming the shell region or before submersing the coated particles in electrolyte is advantageous since it reduces electrolyte consumption during initial battery cycles, and reduces the need for time-consuming battery cycling for stabilization in a factory to obtain an equilibrium condition prior to the use of the battery. Also, the coating can then be formed while the particle has a size closer to the average size it will have during use, reducing strain in the shell layer.

Furthermore, since Lithium-Silicon mixtures are initially amorphous, the amorphous/microcrystalline nature of the coated particles is likely to speed up the kinetics of charging a battery with Lithium. It is more difficult for cracks to propagate through amorphous material, and the internal strain between different regions of the powder with different Lithium contents will be lower if all areas are amorphous, or at least microcrystalline. The formation of amorphous Silicon particles is therefore advantageous in the initial lithiation of the particles.

Additionally, the amorphous or microcrystalline nature of the particles produced by the method according to the present invention is not destroyed in any subsequent treatment step.

According to an embodiment of the invention the coated particles have a maximum transverse dimension of 10 nm-10 μm. Such small coated particles, if used in a Lithium ion battery, will improve the kinetics of the battery.

According to another embodiment of the invention the method the reactant gas comprises silane, monosilane, dichlorosilane, trichlorosilane, or a silicon halide, such as silicon tetrachloride. It should be noted that the expression “reactant gas” as used in this document need not necessarily mean that the reactant gas comprises just one gas. A reactant gas may for example comprise at least one catalyst gas.

According to a further embodiment of the invention the step of coating the produced nano- to micro-scale particles of amorphous or microcrystalline Silicon with passivating material is performed using Chemical Vapour Deposition (CVD), such as vertical CVD, Atomic Layer Deposition (ALD), such as spatial ALD, a plasma-assisted method, or a hot wire method, by immersing produced core region Silicon particles in a fluid containing Lithium ions, or chemical means. The core region Silicon particles are preferably suspended and/or moved while deposition of the coating occurs so that the outer surface of the core region is completely and uniformly coated, and so that particles do not agglomerate during the coating step. Core region Silicon particles may for example be made to fall inside a coating chamber/vessel as they are being coated.

According to an embodiment of the invention the method comprises the step of supplying at least one dopant gas to the reaction chamber of the reactor to dope the core region. By doping the core region and/or the shell region, both the electron mobility and the Lithium mobility can be improved, i.e. the electric conductivity of a core region and/or a shell region is increased by doping. In addition, the doping can be optimized to give the right band bending in the interface between the core region and the shell region, so that no tunneling barrier is introduced. Including dopants in the shell region can change electron mobility and band bending in the shell region towards said interface.

According to another embodiment of the invention the dopant gas contains at least one of the following: Phosphorus, Boron, Arsenic, Gallium, Aluminium.

According to a further embodiment of the invention the passivating material comprises at least one of the following: Carbon, Silicon carbide, Silicon nitride, which will advantageously result in shell region having a relatively low impedance increase.

According to an embodiment of the invention the method comprises the step of doping the passivating material with at least one of the following Phosphorus, Boron, Arsenic, Gallium, Aluminium.

According to another embodiment of the invention the shell region comprises 3-100 monolayers of passivating material.

According to another embodiment of the invention the method comprises the step of producing an electrode, such as an anode, for a battery, such as a Lithium ion battery using the coated particles.

The present invention also concerns a powder of particles having a core region comprising amorphous or microcrystalline Silicon. The particles have a shell region comprising a passivating material. According to an embodiment of the invention the core region has an outer surface that is free from irregularities, roughness and projections

Cracks in Silicon particles have been shown to be initiated from irregularities in the particle surface. The cracks then propagate along grain boundaries, or along preferred crystal orientations. By having a core region with a smooth, amorphous/microcrystalline outer surface and a substantially spherical shape, the likelihood of producing suitable nucleation points for cracks is substantially reduced, thereby delaying cracking tendency, or increasing the particle size fluctuation that can be allowed before cracks are induced.

According to an embodiment of the invention the core region comprises Lithium.

According to another embodiment of the invention the core region has a Lithium content in the range of 50 to 350 atomic-% of the core region's Silicon content.

According to a further embodiment of the invention, the core region comprises another metal, such as Copper or Iron.

According to a further embodiment of the invention the coated particles have a maximum transverse dimension of 10 nm-10 μm.

According to an embodiment of the invention the amorphous or microcrystalline silicon in the core region is doped with at least one of the following: Phosphorus, Boron, Arsenic, Gallium, Aluminium.

According to another embodiment of the invention the passivating material comprises at least one of the following: Carbon, Silicon carbide, Silicon nitride. Coating the particles with the passivating material will preserve the amorphous or microcrystalline nature of the core region.

According to a further embodiment of the invention the shell region is doped with at least one of the following phosphorus, Boron, Arsenic, Gallium, Aluminium.

According to an embodiment of the invention the shell region comprises 3-100 monolayers of passivating material.

According to another embodiment of the invention the particles have a substantially spherical shape.

The present invention also concerns a film that comprises a powder according to any of the embodiments of the invention, and a Lithium ion battery that comprises at least one such film. Powder or a film according to the present invention may for example be used to produce an electrode, such as an anode, for a battery, such as a Lithium ion battery. Since the powder is made from gas precursors, the inclusion of oxygen in the core region of the particles constituting the powder is avoided and there will be no Silicon oxide in the anode, which is desirable.

### BRIEF DESCRIPTION OF THE DRAWINGS

The present invention will hereinafter be further explained by means of non-limiting examples with reference to the appended schematic figures where;

FIG. 1 shows a device for producing nano- to micro-scale core region Silicon particles according to a method according to an embodiment of the invention,

FIG. 2 illustrates a coated particle produced using a method according to the present invention, and

FIG. 3 is a flow chart showing the steps of a method according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

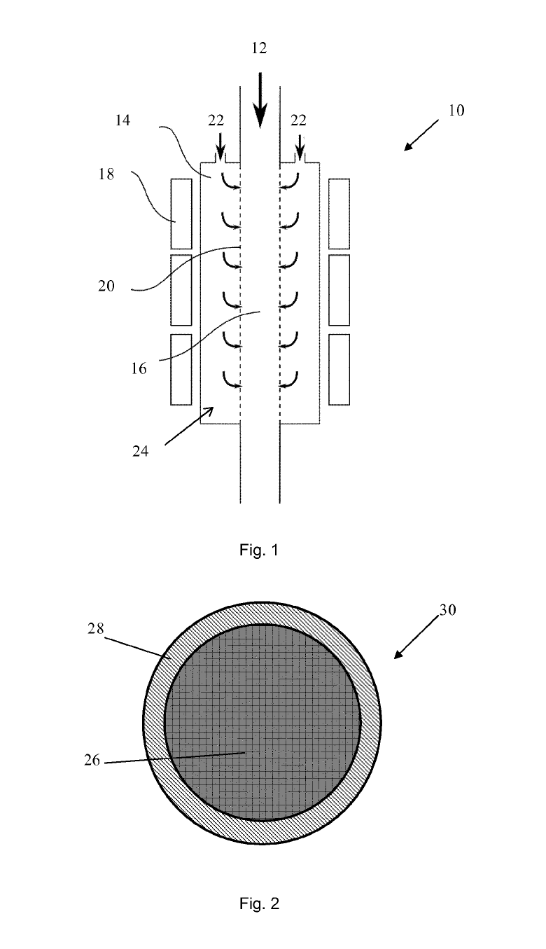

FIG. 1 shows a device 10 for producing nano- to micro-scale particles of Silicon by homogeneous thermal decomposition or reduction of a reactant gas 12 containing Silicon. Such a device 10 may be used to carry out the core region (26 shown in FIG. 2) forming step of a method according to the present invention. The device 10 in the illustrated embodiment comprises a reactor 14 having a reaction chamber 16 with one inlet for reactant gas 12, located at the top of the device 10 for example to obtain a descending reactant gas flow. The reactor 14 may be a Free Space Reactor having stainless steel, silicon carbide or quartz walls for example, which is arranged to decompose the reactant gas 12 homogeneously in the gas phase and thus to grow nano- to micro-scale particles of Silicon. Volatile by-products are removed by gas flow through the reaction chamber 16. Contrary to the multi-stage reactor disclosed in U.S. Pat. No. 4,314,525, in the device according to the present invention no seed particles are introduced into the reactor 14.

Furthermore, particles are not grown on a substrate, such as a hot substrate or deposited on a wafer, such as a heated wafer, and no salt is used to produce the particles. In the method according to the present invention, deposition is carried out on particles floating in heated gas.

The device 10 also comprises means 18, such as heating coils, which are located around the outer wall of the reactor 14 in the illustrated embodiment, to heat the reactant gas 12 to a temperature sufficient for thermal decomposition or reduction of the reactant gas 12 to take place inside the reaction chamber 16. The reaction chamber 16 in the illustrated embodiment is constituted by a single wall constituted entirely by a porous membrane 20, such as a substantially cylindrical tube of material of suitable mechanical and chemical properties. The device 10 also comprises two inlets for a shielding gas which are arranged to supply a shielding gas 22 through the porous membrane 20 to provide a protective inert gas boundary at the wall of the reaction chamber 16 to minimize or prevent the deposition of Silicon on the porous membrane 20 when the device 10 is in use. Optionally, the two inlets may also be used to supply a reaction-influencing gas through the porous membrane 20 to influence the thermal decomposition or reduction of the reactant gas 12 inside the reaction chamber 16.

For example, a silicon-containing reactant gas 12, such as monosilane (SiH₄), diluted in hydrogen, is supplied to the reaction chamber 16. Means 18 for heating the reaction chamber 16 raises the temperature of the reactant gas 12 to a point of thermal decomposition whereby the following reaction takes place and elemental silicon, which may subsequently be removed from the reaction chamber, is formed:

SiH₄→Si+2H₂

For monosilane this temperature is 400° C. Shielding gas 22, such as hydrogen, nitrogen or argon is supplied to a chamber 24 outside the reaction chamber 16 that is delimited by the porous membrane wall 20. The reactor 14 is thereby divided into an outer chamber 24 for shielding gas 22 and an inner reaction chamber 16 where a decomposition or reduction reaction takes places at a distance from the wall(s) of the reaction chamber 16.

The shielding gas 22 in the outer chamber 24 is namely arranged to pass through the porous membrane 20 from the outer chamber 24 to the near wall region of the reaction chamber 16. When the shielding gas 22 enters the reaction chamber 16, the near wall region will be kept free of reactant gas 12 and thus unwanted wall depositions will be avoided.

The reactant gas 12 may contain one or more dopant gases, such as arsine, diborane, phosphine, boron trifluoride, boron-II trifluroride, trimethylboron or any other metal/organic/inorganic dopant gas, which may for example be added in the particles' nucleation and/or growth phase(s). The reactant gas 12 may for example contain a lithium-containing gas, which is supplied during the particle nucleation phase, and/or after the particle nucleation phase. It should be noted that a dopant gas may additionally or alternatively be supplied through the porous membrane in the illustrated embodiment.

Depending on the operation temperature and requirements for the finished product, the porous membrane 20 may comprise a metal alloy such as AISI316, Inconel, 253MA or HT800. The membrane may also be produced from porous sintered silicon-nitride Si₃N₄, porous silica SiO₂, porous alumina Al₂O₃ or any other suitable material. It is not however necessary for a reactor in which a method according to the present invention is carried out to comprise a porous membrane 20.

It should be noted that the reaction chamber dimensions may vary from having a maximum transverse dimension of a few milimetres to a few metres.

The thermal decomposition or reduction of the reactant gas 12 inside the reaction chamber 16 is controlled so as to produce a powder of amorphous or microcrystalline Silicon particles, which will subsequently form a core region 26 of a coated particle 26. The thermal decomposition or reduction of the reactant gas 12 inside the reaction chamber 16 may for example be controlled by adjusting the temperature, pressure, flow rate, heat capacity and/or composition, of the reactant gas 12 (and/or a reaction-influencing gas).

The outer surface of Silicon particles which will subsequently form a core region 26 of a coated particle 26 has an outer surface that is free from irregularities, roughness and projections.

The thermal decomposition or reduction of the reactant gas inside the reaction chamber may be influenced by changing at least one of the following characteristics of the reactant has and/or reaction-influencing gas: temperature, pressure, flow rate, heat capacity, composition, dopant type(s) and/or amount(s), catalyst type(s) and/or amount(s), and/or concentration of one or more components of said gas(es). By changing at least one of the characteristics of the reactant gas and/or reaction-influencing gas, the thermal decomposition or reduction of the reactant gas inside the reaction chamber, and consequently the formation and/or growth of particles, and/or their morphology and/or crystallinity, may be controlled in order to obtain a final product having the desired characteristics.

The actual dimensions of the components of the device 10 are not especially critical. In addition, operating parameters such as gas flow rates and operating temperatures can be established experimentally for different devices having different sizes and configurations.

The powder of amorphous or microcrystalline Silicon particles produced in the reactor are then coated with passivating material, such as Carbon, Silicon carbide, Silicon nitride, using Chemical Vapour Deposition (CVD), such as vertical CVD, Atomic Layer Deposition (ALD), a plasma-assisted method, or a hot wire method or by immersing them in a fluid containing Lithium ions to produce a shell region 28. The shell region 28 may comprise 3-100 monolayers of passivating material so as to be thin but mechanically robust, and/or may be doped with Phosphorus, Boron, Arsenic, Gallium or Aluminium. The coating step may be carried out inside the same reactor used for the production of the core region 26 particles, or inside a different vessel.

The coated particles 30, which are substantially spherical, and which preferably have a maximum transverse dimension of 10 nm-10 μm and may be used for several applications. The coated particles 30 may for example be used to produce an anode for a Lithium ion battery. By using Silicon instead of Carbon anodes in Lithium ion batteries, or at least replacing part of the Carbon with Silicon, it has been shown that the storage capacity can be substantially increased.

Doped coated silicon particles may be used for local increased carrier density under the contacts of a solar cell for example (which may be a doped Silicon sheet) or other high level industrial processes to increase photovoltaic cell performance.

Doped coated silicon particles may be used in the direct wafer process. In this process wafers are produced directly by passing large currents through a thin powder bed and thus directly melt and produce the wafer. In order to produce a functioning solar cell there is an inherent need for making a P-N junction. The common method for making a cell is to have a feedstock material that is either P- or N-doped from the start. This means that the material is deliberately “contaminated” with either atoms having one excess electron, or atoms missing one electron compared to silicon. When these atoms are included in the silicon lattice the excess electron or hole will make a permanent charge in the material. By doping each side of the silicon wafer differently, a permanent charge field is produced and this makes the excited electrons wander distinctly to the contacts and they may thus be collected.

Coated Silicon particles may also be used to produce Silicon inks, transistors, rectifiers, and other solid-state electronic devices.

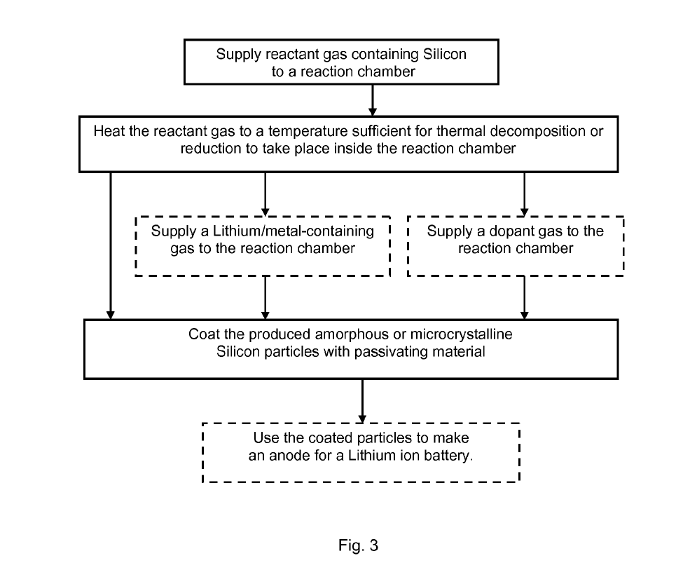

FIG. 3 is a flow chart showing the steps of a method according to the present invention. The method comprises the steps of supplying reactant gas to a reaction chamber of a reactor and heating the reactant gas to a temperature sufficient for thermal decomposition or reduction of the reactant gas to take place inside the reaction chamber in order to produce amorphous or microcrystalline Silicon particles (core region 26). A Lithium- or metal-containing gas, and/or a dopant gas may also be supplied to reaction chamber to lithiate, add metal or dope the Silicon particles respectively. The amorphous or microcrystalline Silicon particles (core region 26) are then coated with passivating material so to form coated particles 30 having a core region 26 and a shell region 28. The coated particles 30 may then be used to produce a film or anode for a Lithium ion battery or for any other suitable application.

Further modifications of the invention within the scope of the claims would be apparent to a skilled person.

1. A method for producing a powder of particles, the method comprising:
supplying a reactant gas comprising silicon to a reaction chamber of a reactor, and heating the reactant gas to a temperature sufficient for thermal decomposition or reduction of the reactant gas to take place inside the reaction chamber to thereby produce nano- to micro-scale particles of amorphous or microcrystalline silicon, and then
coating the particles with a passivating material, to obtain a powder of coated particles comprising a core region and a shell region, wherein the core region comprises amorphous or microcrystalline silicon and the shell region comprises the passivating material.

2. The method according to claim 1, further comprising supplying at least one gas comprising a metal to the reaction chamber of the reactor.

3. The method according to claim 2, wherein the metal comprises lithium, and the gas comprising the lithium lithiates the core region.

4. The method according to claim 3, wherein the gas comprising the lithium lithiates the core region such that the core region has a lithium content in a range of 50 to 350 atomic-% of a silicon content of the core region.

5. The method according to claim 1, wherein the coated particles have a maximum transverse dimension of 10 nm-10 μm.

6. The method according to claim 1, wherein the reactant gas comprises a silane, monosilane, dichlorosilane, or trichlorosilane.

7. The method according to claim 1, wherein the coating of the particles is performed using chemical vapor deposition, atomic layer deposition, a plasma-assisted method, a hot wire method or by immersing the particles in a fluid comprising lithium ions.

8. The method according to claim 1, further comprising supplying at least one dopant gas to the reaction chamber of the reactor to dope the core region.

9. The method according to claim 8, wherein the dopant gas comprises at least one element selected from the group consisting of phosphorus, boron, arsenic, gallium, and aluminum.

10. The method according to claim 1, wherein the passivating material comprises at least one member selected from the group consisting of carbon, silicon carbide, and silicon nitride.

11. The method according to claim 1, further comprising doping the passivating material with at least one element selected from the group consisting of phosphorus, boron, arsenic, gallium, and aluminum.

12. The method according to claim 1, wherein the shell region comprises 3-100 monolayers of the passivating material.

13. The method according to claim 1, further comprising producing an electrode for a lithium ion battery using the coated particles.

14. A powder of coated particles having a core region comprising amorphous or microcrystalline silicon, and having a shell region comprising a passivating material.

15. The powder according to claim 14 wherein the core region has an outer surface that is free from irregularities, roughness and projections.

16. The powder according to claim 14, wherein the core region comprises a metal.

17. The powder according to claim 16, wherein the core region comprises lithium.

18. The powder according to claim 17, wherein the core region has a lithium content in a range of 50 to 350 atomic-% of a silicon content of the core region.

19. The powder according to claim 14, wherein the coated particles have a maximum transverse dimension of 10 nm-10 μm.

20. The powder according to claim 14, wherein the amorphous or microcrystalline silicon in the core region is doped with at least one element selected from the group consisting of phosphorus, boron, arsenic, gallium, and aluminum.

21. The powder according to claim 14, wherein the passivating material comprises at least one member selected from the group consisting of carbon, silicon carbide, and silicon nitride.

22. The powder according to claim 14, wherein the shell region is doped with at least one element selected from the group consisting of phosphorus, boron, arsenic, gallium, and aluminum.

23. The powder according to claim 14, wherein the shell region comprises 3-100 monolayers of the passivating material.

24. The powder according to claim 14, wherein the particles have a substantially spherical shape.

25. A film comprising the powder according to claim 14.

26. A lithium ion battery, a comprising the powder according to claim 14.

27. The method according to claim 1, wherein the particles have a substantially spherical shape.
